(19) United States
(12) Patent Application Publication
(10) Pub. No.: US 2013/0269661 A1
(43) Pub. Date: Oct. 17, 2013

(54) VAPOR FUEL TREATMENT APPARATUS

(71) Applicants: DENSO CORPORATION, Kariya-city (JP); HAMANAKODENSO CO., LTD., Kosai-city (JP)

(72) Inventors: Takashi SENDA, Niwa-gun (JP); Masaomi INOUE, Kariya-city (JP); Hidetoshi OOIWA, Anjo-city (JP); Tetsunori INOGUCHI, Hamamatsu-city (JP); Kosuke SHIRAI, Toyohashi-city (JP)

(73) Assignees: HAMANAKODENSO CO., LTD., Kosai-city (JP); DENSO CORPORATION, Kariya-city (JP)

(21) Appl. No.: 13/860,162

(22) Filed: Apr. 10, 2013

(30) Foreign Application Priority Data
Apr. 17, 2012 (JP) 2012-93738

(51) Int. Cl. F02M 25/08

(52) U.S. Cl. CPC F02M 25/0836
USPC 123/520

(57) ABSTRACT

A control part conducts a pulse width modulation control for a first valve and a second valve in a manner that a sum of a first flow rate of fluid flowing through a first passage and a second flow rate of fluid flowing through a second passage agrees with a target flow rate. When the target flow rate is less than a sum of the maximum of the first flow rate and the maximum of the second flow rate, the control part controls a control timing of a first signal driving the first valve and a control timing of a second signal driving the second valve to be different from each other.

### CROSS REFERENCE TO RELATED APPLICATION

This application is based on Japanese Patent Application No. 2012-93738 filed on Apr. 17, 2012, the disclosure of which is incorporated herein by reference in its entirety.

### TECHNICAL FIELD

The present disclosure relates to a vapor fuel treatment apparatus.

### BACKGROUND

In a hybrid car or a car having an idling stop system, a negative pressure in an intake pipe tends to become low for a long time, because operation frequency of an internal combustion engine is decreased. If the negative pressure in the intake pipe falls, an opportunity to purge vapor fuel to the engine will be reduced and a pressure difference required for the purging will be decreased, so it becomes difficult to secure a predetermined purge flow rate.

WO 08/090657 (US 2011/0000563) describes a vapor fuel treatment apparatus, in which two purge valves area arranged in parallel in a purging passage where vapor fuel flows, so as to increase the purge flow rate.

However, if the two purge valves are simultaneously opened or closed, pressure pulsation generated in the purging passage may become large. When the pressure pulsation becomes large, the pulsation sound or the variation in the air-fuel ratio between the cylinders may become large. Especially when the negative pressure in the intake pipe is large, for example, at the engine idling time, the pressure pulsation becomes large. At this time, loud pulsation sound may be transmitted to a passenger compartment at the engine idling time.

### SUMMARY

According to an example of the present disclosure, a vapor fuel treatment apparatus including a canister which adsorbs vapor fuel generated in a fuel tank, the vapor fuel adsorbed by the canister being introduced into an internal combustion engine via an intake pipe, the vapor fuel treatment apparatus includes a first electromagnetism drive valve, a second electromagnetism drive valve, a target flow rate calculator, a total maximum calculator, and a control part. The first electromagnetism drive valve is arranged in a first passage having a first end connected to the canister and a second end connected to the intake pipe. The first electromagnetism drive valve has a first valve component which reciprocates to open or close the first passage, and a first electromagnetism actuator which drives the first valve component in a valve opening direction when a first driving command signal having a rectangle pulse form is input. The second electromagnetism drive valve is arranged in a second passage having a first end connected to the canister and a second end connected to the intake pipe. The second electromagnetism drive valve has a second valve component which reciprocates to open or close the second passage, and a second electromagnetism actuator which drives the second valve component in a valve opening direction when a second driving command signal having a rectangle pulse form is input. The target flow rate calculator calculates a target purge flow rate of fluid including the vapor fuel to be introduced into the internal combustion engine based on an operational status of the internal combustion engine. The total maximum calculator calculates a sum of a first maximum flow rate and a second maximum flow rate as a total maximum. The first maximum flow rate is a flow rate of fluid flowing through the first passage when the first valve component has a maximum opening. The second maximum flow rate is a flow rate of fluid flowing through the second passage when the second valve component has a maximum opening. The control part carries out a pulse width modulation control for the first electromagnetism drive valve and the second electromagnetism drive valve by outputting the first driving command signal and the second driving command signal to the first electromagnetism actuator and the second electromagnetism actuator respectively in a manner that a sum of a flow rate of fluid flowing through the first passage and a flow rate of fluid flowing through the second passage agrees with the target purge flow rate. The control part controls a rising timing of the first driving command signal and a rising timing of the second driving command signal to be different from each other, or controls a falling timing of the first driving command signal and a falling timing of the second driving command signal to be different from each other, when the target flow rate is less than the sum of the first maximum flow rate and the second maximum flow rate.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a vapor fuel treatment apparatus according to a first embodiment;

FIG. 2A is a time chart illustrating an example of a pulse width modulation control conducted by a control part of the vapor fuel treatment apparatus of the first embodiment, and FIG. 2B is a time chart illustrating an example of an on/off drive control conducted by the control part of the vapor fuel treatment apparatus of the first embodiment;

FIG. 3A is an explanatory view illustrating operation patterns of the vapor fuel treatment apparatus when a second maximum flow rate is larger than a first maximum flow rate, FIG. 3B is an explanatory view illustrating operation patterns of the vapor fuel treatment apparatus when a second maximum flow rate is the same as a first maximum flow rate, and FIG. 3C is an explanatory view illustrating operation patterns of the vapor fuel treatment apparatus when a first maximum flow rate is larger than a second maximum flow rate;

FIG. 4 is a flow chart illustrating a purging treatment conducted by the vapor fuel treatment apparatus of the first embodiment;

FIG. 5 is a time chart illustrating an example of the purging treatment by the vapor fuel treatment apparatus of the first embodiment;

FIG. 6 is a time chart illustrating a second driving command signal shifted in a duty ratio, a second driving command signal shifted in a phase, a second driving command signal shifted in a duty ratio and a phase, and a second driving command signal shifted in a cycle period relative to a first driving command signal according to a second embodiment; and

FIG. 7 is a flow chart illustrating a purging treatment conducted by a vapor fuel treatment apparatus of the second embodiment.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

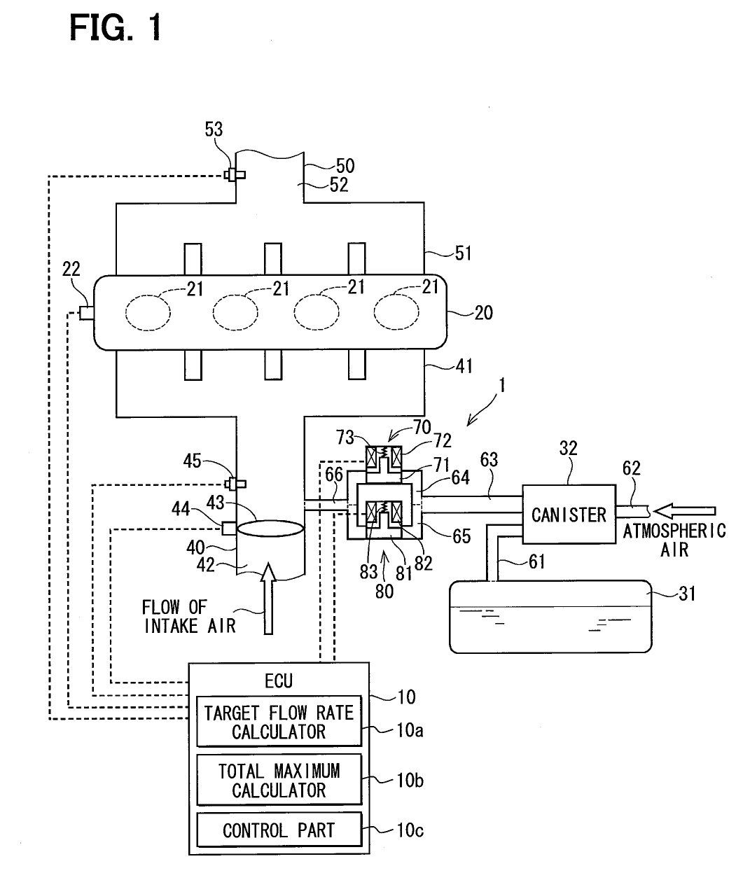

A vapor fuel treatment apparatus 1 according to a first embodiment is shown in FIG. 1.

The vapor fuel treatment apparatus 1 is mounted to a vehicle having an internal combustion engine 20. The engine 20 is driven by fuel such as gasoline. Fuel to be supplied to the engine 20 is stored in a fuel tank 31, and vapor fuel is generated in the fuel tank 31. The vapor fuel treatment apparatus 1 treats fuel by introducing and purging the vapor fuel from the fuel tank 31 to the engine 20.

The engine 20 has, for example, four cylinders 21 as a four-cylinder engine. An intake pipe 40 and an exhaust pipe 50 are connected to the engine 20. The end of the intake pipe 40 adjacent to the engine 20 is branched to four parts as an intake manifold 41, which are respectively connected to the cylinders 21. The end of the exhaust pipe 50 adjacent to the engine 20 is branched to four parts as an exhaust manifold 51, which are respectively connected to the cylinders 21. An intake port (not shown) is defined in the opposite end of the intake pipe 40 opposite from the engine 20. An exhaust port (not shown) is defined in the opposite end of the exhaust pipe 50 opposite from the engine 20. The intake port and the exhaust port are opened to atmospheric air.

While the engine 20 is operated, air is drawn into the cylinder 21 via the intake port and an intake passage 42 defined in the intake pipe 40. Hereafter, the air drawn into the cylinder 21 is referred as intake air. Gasoline (fuel) is mixed into the intake air and is combusted in the cylinder 21. Combustion gas generated by the combustion is exhausted to atmospheric air from the cylinder 21 via an exhaust passage 52 defined in the exhaust pipe 50 and the exhaust port. Hereafter, air containing the combustion gas is referred as exhaust gas.

A throttle valve 43 is disposed between the intake port of the intake passage 42 and the intake manifold 41. The throttle valve 43 adjusts a flow rate of the intake air by opening or closing the intake passage 42.

A first end of a tank passage 61 is connected to the fuel tank 31. A second end of the tank passage 61 is connected to the canister 32. The canister 32 adsorbs vapor fuel flowing from the fuel tank 31 through the tank passage 61.

A first end of an atmospheric passage 62 is connected to the fuel tank 31. A second end of the atmospheric air passage 62 is opened to atmospheric air.

A first end of a purging passage 63 is connected to the canister 32. A second end of the purging passage 63 is connected to a first end of a first passage 64 and a first end of a second passage 65.

A first end of a purging passage 66 is connected to a second end of the first passage 64 and a second end of the second passage 65. A second end of the purging passage 66 is connected to the intake passage 42 at a downstream of the throttle valve 43 adjacent to the intake manifold 41.

When a negative pressure arises in the intake pipe 40, i.e., the downstream of the throttle valve 43 in the intake passage 42, the vapor fuel adsorbed by the canister 32 flows through the purging passage 63, the first passage 64 and the second passage 65, and the purging passage 66 into the intake passage 42 together with fluid (air) flowing from the atmospheric passage 62. Hereafter, fluid which includes the vapor fuel and which circulates the purging passage 63, the first passage 64 and the second passage 65, and the purging passage 66 is referred as fluid containing vapor fuel. The fluid containing vapor fuel is introduced and purged from the intake passage 42 via the intake manifold 41 to the cylinder 21 of the engine 20 together with intake air. The vapor fuel in the fluid is combusted in the cylinder 21 with gasoline corresponding to fuel. Thus, the vapor fuel in the fuel tank 31 is processed.

The vapor fuel treatment apparatus 1 has a first electromagnetism drive valve 70, a second electromagnetism drive valve 80, and an electronic control unit (ECU) 10.

The first electromagnetism drive valve 70 is arranged in the first passage 64. The first electromagnetism drive valve 70 has a first valve component 71, a first electromagnetism actuator 72, and a first biasing component 73. The first valve component 71 reciprocates to open and close the first passage 64. The first electromagnetism actuator 72 drives the first valve component 71 in a valve opening direction, when a first driving command signal of rectangle pulse form is inputted from the ECU 10. The first biasing component 73 biases the first valve component 71 in a valve closing direction. When the first valve component 71 is opened, fluid is allowed to flow through the first passage 64. On the other hand, when the first valve component 71 is closed, fluid is prohibited from flowing through the first passage 64.

The second electromagnetism drive valve 80 is arranged in the second passage 65. The second electromagnetism drive valve 80 has a second valve component 81, a second electromagnetism actuator 82, and a second biasing component 83. The second valve component 81 reciprocates to open and close the second passage 65. The second electromagnetism actuator 82 drives the second valve component 81 in a valve opening direction, when a second driving command signal of rectangle pulse form is inputted from the ECU 10. The second biasing component 83 biases the second valve component 81 in a valve closing direction. When the second valve component 81 is opened, fluid is allowed to flow through the second passage 65. On the other hand, when the second valve component 81 is closed, fluid is prohibited from flowing through the second passage 65.

The ECU 10 is a small-sized computer having a CPU corresponding to a calculator, ROM and RAM corresponding to a memory, and an input-and-output interface. The ECU 10 conducts processing according to a program memorized in the ROM based on a signal from a sensor attached to each part of the vehicle, and comprehensively controls the vehicle by controlling various equipments of the vehicle.

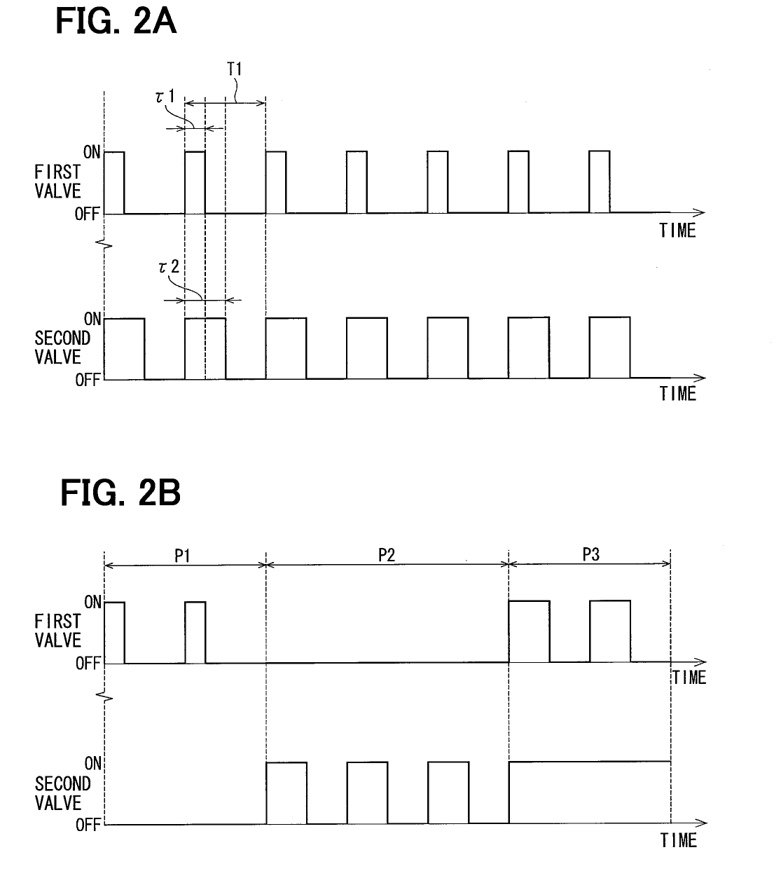

The ECU 10 is connected to the first electromagnetism actuator 72 and the second electromagnetism actuator 82. The ECU 10 outputs a first driving command signal, for example shown on the upper side in FIG. 2A, to the first electromagnetism actuator 72. Moreover, the ECU 10 outputs a second driving command signal, for example shown on the lower side in FIG. 2A, to the second electromagnetism actuator 82. The first driving command signal and the second driving command signal are rectangle-pulse-shaped signals having a predetermined cycle period.

The first electromagnetism actuator 72 drives the first valve component 71 in the valve opening direction, when the inputted first driving command signal is ON, thereby opening the first valve component 71. On the other hand, when the first driving command signal inputted into the first electromagnetism actuator 72 is OFF, the first valve component 71 is moved in the valve closing direction by the biasing force of the first biasing component 73, thereby closing the first valve component 71.

The second electromagnetism actuator 82 drives the second valve component 81 in the valve opening direction, when the inputted second driving command signal is ON, thereby opening the second valve component 81. On the other hand, when the second driving command signal inputted into the second electromagnetism actuator 82 is OFF, the second valve component 81 is moved in the valve closing direction by the biasing force of the second biasing component 83, thereby closing the second valve component 81.

The ECU 10 flexibly changes the pulse width (ON period) of the first driving command signal and the second driving command signal. Thereby, the ECU 10 can set the valve opening period and timing for the first valve component 71 and the second valve component 81.

Thus, the ECU 10 controls the first electromagnetism drive valve 70 and the second electromagnetism drive valve 80 by outputting the first driving command signal and the second driving command signal, respectively, to the first electromagnetism actuator 72 and the second electromagnetism actuator 82. That is, the ECU 10 carries out a pulse width modulation (PWM) control relative to the first electromagnetism drive valve 70 and the second electromagnetism drive valve 80.

As shown in FIG. 2A, the cycle period (frequency) and the phase are the same between the first driving command signal and the second driving command signal, in the present embodiment. For example, the first driving command signal and the second driving command signal have the same cycle period T1.

The pulse width (ON period) T1 of the first driving command signal relative to the period T1 is one fourth (¼), at this time, the duty ratio of the first driving command signal is 0.25. Hereafter, the duty ratio of the first driving command signal is referred as a first duty ratio.

The pulse width (ON period) T2 of the second driving command signal relative to the period T1 is one half (½), at this time, the duty ratio of the second driving command signal is 0.5. Hereafter, the duty ratio of the second driving command signal is referred as a second duty ratio.

As shown in FIG. 2B, the first duty ratio in a period P1 is 0.25. The first duty ratio in a period P2 is 0. The first duty ratio in a period P3 is 0.5. Moreover, the second duty ratio in the period P1 is 0. The second duty ratio in the period P2 is 0.5. The second duty ratio in the period P3 is 1.

The ECU 10 carries out the PWM control for the first electromagnetism drive valve 70 and the second electromagnetism drive valve 80 by outputting the first driving command signal and the second driving command signal to the first electromagnetism actuator 72 and the second electromagnetism actuator 82, respectively, while changing the first duty ratio and the second duty ratio. Thereby, the first electromagnetism drive valve 70 and the second electromagnetism drive valve 80 are driven according to the first duty ratio and the second duty ratio, respectively, to open the first valve component 71 and the second valve component 81. While the first valve component 71 and the second valve component 81 are opened, when a negative pressure arises in the intake pipe 40, the fluid containing vapor fuel flows into the intake passage 42 of the intake pipe 40 via the purging passage 63, the first passage 64, the second passage 65, and the purging passage 66. Thereby, vapor fuel is purged to the engine 20.

If the first driving command signal shown in FIG. 2B is inputted into the first electromagnetism actuator 72 in the period P1, the first electromagnetism drive valve 70 is driven with the ON period of 25% because the first duty ratio is 0.25. In the period P2, the first duty ratio is 0, so the first electromagnetism drive valve 70 is driven with the ON period of 0% (OFF drive). In the period P3, the first duty ratio is 0.5, so the first electromagnetism drive valve 70 is driven with the ON period of 50%.

If the second driving command signal shown in FIG. 2B is inputted into the second electromagnetism actuator 82 in the period P1, the second electromagnetism drive valve 80 is driven with the ON period of 0% (OFF drive) because the second duty ratio is 0. In the period P2, the second duty ratio is 0.5, so the second electromagnetism drive valve 80 is driven with the ON period of 50%. In the period P3, the second duty ratio is 1, so the second electromagnetism drive valve 80 is driven with the ON period of 100% (ON drive).

Hereafter, when the first duty ratio is 0 like the period P2, the drive of the first electromagnetism drive valve 70 is defined to have OFF drive. When the first duty ratio is 1, the drive of the first electromagnetism drive valve 70 is defined to have ON drive. On the other hand, when the first duty ratio is larger than 0 and smaller than 1 like the period P1 and the period P3, the drive of the first electromagnetism drive valve 70 is defined to have PWM drive.

Similarly, when the second duty ratio is 0 like the period P1, the drive of the second electromagnetism drive valve 80 is defined to have OFF drive. When the second duty ratio is 1 like the period P3, the drive of the second electromagnetism drive valve 80 is defined to have ON drive. The drive of the second electromagnetism drive valve 80 is defined to have PWM drive when the second duty ratio is larger than 0 and smaller than 1 like the period P2. The ON drive and the OFF drive are referred as ON/OFF drive in comparison to PWM drive.

That is, in the period P1, the first electromagnetism drive valve 70 has the PWM drive (25%) and the second electromagnetism drive valve 80 has the ON/OFF drive (0%, OFF drive). In the period P2, the first electromagnetism drive valve 70 has the ON/OFF drive (0%, OFF drive) and the second electromagnetism drive valve 80 has the PWM drive (50%). In the period P3, the first electromagnetism drive valve 70 has the PWM drive (50%) and the second electromagnetism drive valve 80 has the ON/OFF drive (100%, ON drive).

An air fuel ratio sensor 53 is connected to the ECU 10. The air fuel ratio sensor 53 is disposed in the exhaust pipe 50 so as to be exposed to the exhaust passage 52. The air fuel ratio sensor 53 detects the combustion air-fuel ratio in the engine 20 based on the oxygen concentration and non-combustion gas concentration in the exhaust gas over the whole region from the rich region to the lean region, and feeds the detection result back to the ECU 10. The ECU 10 produces the optimal combustion state in accordance with the operational status of the engine 20 based on the information fed back from the air fuel ratio sensor 53.

A crank position sensor 22 is connected to the ECU 10. The crank position sensor 22 is attached to the engine 20, and detects the rotation position of the crankshaft (not shown). The ECU 10 computes the rotation speed of the crankshaft of the engine 20 based on the signal from the crank position sensor 22.

The ECU 10 is connected to an actuator 44 which drives to open and close the throttle valve 43. The ECU 10 acquires information about an accelerator opening from the accelerator position sensor (not shown), and outputs a driving command to the actuator 44 based on the acquired information about the accelerator opening. Thereby, the opening of the throttle valve 43 is changed to control the quantity of intake air which flows through the intake passage 42.

The ECU 10 is connected to an injector (not shown) which injects to supply fuel to the engine 20. The ECU 10 determines the injection quantity of fuel to the engine 20 from the injector based on the quantity of the intake air drawn by the engine 20, the rotation speed of the engine 20, and the information from the air fuel ratio sensor 53, etc., and controls the injector to inject the determined quantity of fuel. The ECU 10 ignites fuel in the cylinder 21 with the ignition plug (not shown). Thereby, fuel is combusted to rotate the crankshaft, and the driving force of the vehicle is generated.

An intake pipe pressure sensor 45 is connected to the ECU 10. The intake pipe pressure sensor 45 is arranged in the intake pipe 40 so as to be exposed to the intake passage 42. The intake pressure sensor 45 detects pressure in the intake pipe 40. The ECU 10 computes a difference pressure between the pressure in the intake pipe 40 and an atmospheric pressure based on the signal from the intake pipe pressure sensor 45. In addition, when the throttle valve 43 is closed, for example, at the idling time of the engine 20, the difference pressure, i.e., the negative pressure, between the pressure in the intake pipe 40 and an atmospheric pressure becomes large.

A target flow rate calculator 10a of the ECU 10 computes a target purge flow rate, which is a target flow rate of the fluid containing vapor fuel introduced and purged to the engine 20, based on the operational status such as rotation speed of the engine 20. More specifically, the target purge flow rate is decreased when the rotation number of the engine 20 is small, and the target purge flow rate is increased when the rotation number of the engine 20 is high.

The ECU 10 computes the first maximum flow rate which is a flow rate of the fluid containing vapor fuel which flows through the first passage 64, when the first valve component 71 opens with the maximum opening. The ECU 10 computes the second maximum flow rate which is a flow rate of the fluid containing vapor fuel which flows through the second passage 65, when the second valve component 81 opens with the maximum opening.

A total maximum calculator 10b of the ECU 10 computes the sum of the first maximum flow rate and the second maximum flow rate as a total maximum. The characteristics of the first maximum flow rate and the second maximum flow rate are determined, for example, by the passage diameters of the first passage 64 and the second passage 65 and the maximum stroke amounts of the first valve component 71 and the second valve component 81. Because the first maximum flow rate and the second maximum flow rate are changed by the pressures in the intake pipe 40, the total maximum calculator 10b of the ECU 10 computes the first maximum flow rate, the second maximum flow rate, and the total maximum based on the signal from the intake pipe pressure sensor 45.

A control part 10c of the ECU 10 conducts the PWM control relative to the first electromagnetism drive valve 70 and the second electromagnetism drive valve 80, by outputting the first driving command signal and the second driving command signal to the first electromagnetism actuator 72 and the second electromagnetism actuator 82, respectively, in a manner that a total flow rate which is the sum of the flow rate of fluid containing vapor fuel which flows through the first passage 64 and the flow rate of fluid containing vapor fuel which flows through the second passage 65 will be in agreement with the target purge flow rate.

When the target purge flow rate is less than the total maximum, the ECU 10 controls the falling timing of the first driving command signal and the falling timing of the second driving command signal to become different from each other. More specifically, the ECU 10 controls the first duty ratio and the second duty ratio to differ from each other, when the target purge flow rate is less than the total maximum, so that the falling timing of the first driving command signal and the falling timing of the second driving command signal differ from each other.

More specifically, as shown in FIG. 2B, when the target purge flow rate is less than the total maximum, the ECU 10 controls the first driving command signal and the second driving command signal in a manner that either one of the first duty ratio and the second duty ratio is set to 0 or 1 in a predetermined period and that the other of the first duty ratio and the second duty ratio is set to be larger than 0 and smaller than 1 in the predetermined period. Thus, the falling timing of the first driving command signal and the falling timing of the second driving command signal become different from each other.

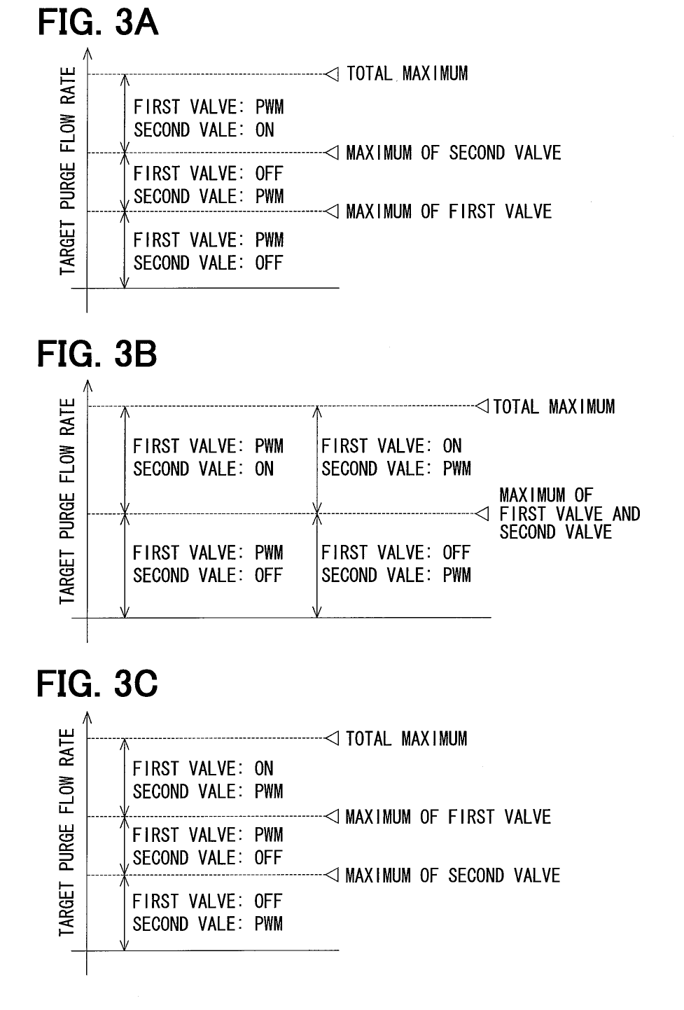

For example, as shown in FIG. 3A, in a case where the second maximum flow rate is larger than the first maximum flow rate, when the target purge flow rate is less than the first maximum flow rate, the ECU 10 carries out the PWM drive for the first electromagnetism drive valve 70 and carries out the OFF drive for the second electromagnetism drive valve 80. When the target purge flow rate is more than or equal to the first maximum flow rate and is less than the second maximum flow rate, the ECU 10 carries out the OFF drive for the first electromagnetism drive valve 70, and carries out the PWM drive for the second electromagnetism drive valve 80. When the target purge flow rate is more than or equal to the second maximum flow rate and is less than the total maximum, the ECU 10 conducts the PWM drive for the first electromagnetism drive valve 70 and conducts the ON drive for the second electromagnetism drive valve 80.

For example, as shown in FIG. 3B, in a case where the first maximum flow rate and the second maximum flow rate are equal with each other, when the target purge flow rate is less than the first maximum flow rate or the second maximum flow rate, the ECU 10 carries out the PWM drive for the first electromagnetism drive valve 70, and carries out the OFF drive for the second electromagnetism drive valve 80. When the target purge flow rate is more than or equal to the first maximum flow rate or the second maximum flow rate and is less than the total maximum, the ECU 10 carries out the PWM drive for the first electromagnetism drive valve 70 and carried out the ON drive for the second electromagnetism drive valve 80.

Alternatively, in the case where the first maximum flow rate and the second maximum flow rate are equal with each other, when the target purge flow rate is less than the first maximum flow rate or the second maximum flow rate, the ECU 10 may carry out the OFF drive for the first electromagnetism drive valve 70, and may carry out the PWM drive for the second electromagnetism drive valve 80. When the target purge flow rate is more than or equal to the first maximum flow rate or the second maximum flow rate and is less than the total maximum, the ECU 10 may carry out the ON drive for the first electromagnetism drive valve 70 and may carry out the PWM drive for the second electromagnetism drive valve 80.

For example, as shown in FIG. 3C, in a case where the first maximum flow rate is larger than the second maximum flow rate, when the target purge flow rate is less than the second maximum flow rate, the ECU 10 carries out the OFF drive for the first electromagnetism drive valve 70, and carries out the PWM drive for the second electromagnetism drive valve 80. When the target purge flow rate is more than or equal to the second maximum flow rate and is less than the first maximum flow rate, the ECU 10 carries out the PWM drive for the first electromagnetism drive valve 70 and carries out the OFF drive for the second electromagnetism drive valve 80. When the target purge flow rate is more than or equal to the first maximum flow rate and is less than the total maximum, the ECU 10 carries out the ON drive for the first electromagnetism drive valve 70 and carries out the PWM drive for the second electromagnetism drive valve 80.

In addition, when the target purge flow rate is more than or equal to the total maximum, the ECU 10 outputs the first driving command signal and the second driving command signal to the first electromagnetism actuator 72 and the second electromagnetism actuator 82, respectively, so that both the first duty ratio and the second duty ratio are set to 1. Thereby, both the first electromagnetism drive valve 70 and the second electromagnetism drive valve 80 are made to have the ON drive.

The ECU 10 carries out the PWM control for the first electromagnetism drive valve 70 and the second electromagnetism drive valve 80 as mentioned above, thereby the falling timing of the first driving command signal and the falling timing of the second driving command signal are made different from each other when the target purge flow rate is less than the total maximum. Thereby, since the valve closing timing is made different between the first valve component 71 and the second valve component 81, a pressure pulsation is restricted from being generated in the purging passage 63 and the purging passage 66.

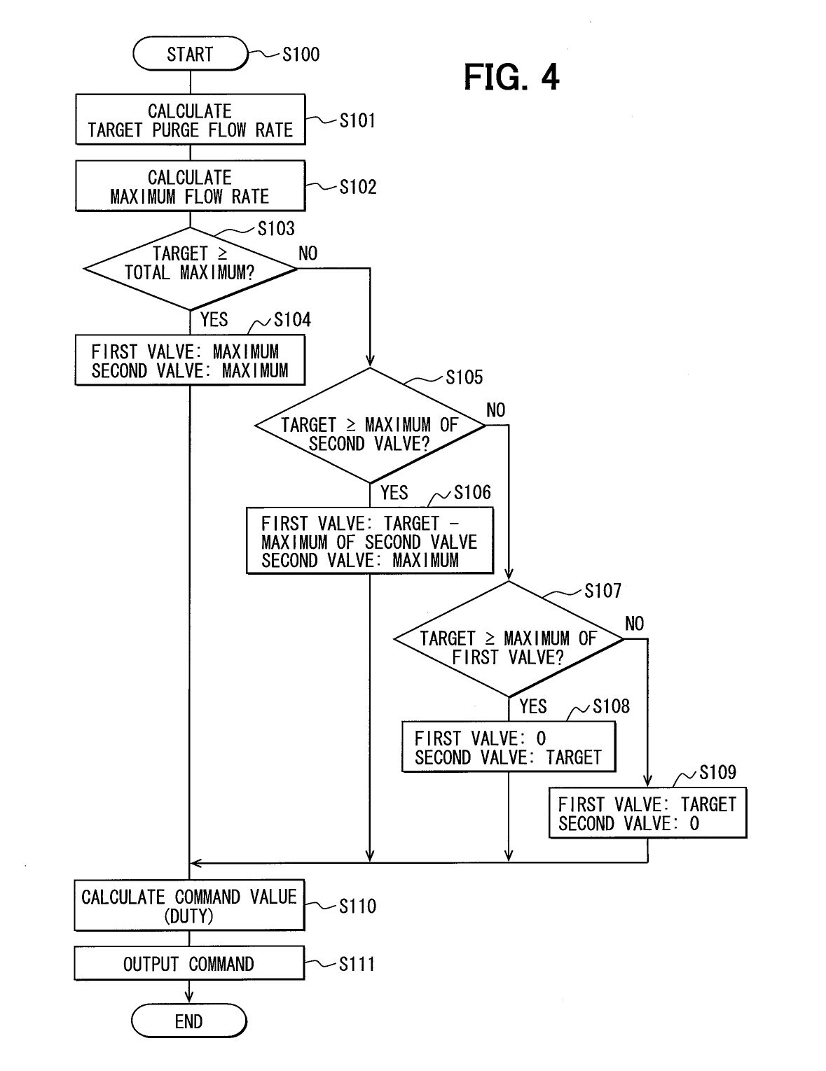

Next, the vapor fuel purging treatment by the ECU 10 of the vapor fuel treatment apparatus 1 is explained based on FIG. 4. The vapor fuel purging treatment is started at S100 of FIG. 4 when a predetermined condition is met, for example, when the feedback control using the air fuel ratio sensor 53 is being performed after the completion of warming-up of the engine 20. FIG. 4 represents a treatment where the second maximum flow rate is larger than the first maximum flow rate.

In S101, the target flow rate calculator 10a of the ECU 10 computes the target purge flow rate. Then, the ECU 10 shifts to S102.

In S102, the total maximum calculator 10b of the ECU 10 computes the first maximum flow rate, the second maximum flow rate, and the total maximum that is the sum of the first maximum flow rate and the second maximum flow rate. Then, the ECU 10 shifts to S103.

In S103, the ECU 10 determines whether the target purge flow rate is more than or equal to the total maximum. When the target purge flow rate is more than or equal to the total maximum (S103:YES), the ECU 10 shifts to S104. When the target purge flow rate is less than the total maximum (S103:NO), the ECU 10 shifts to S105.

In S104, the ECU 10 sets a directive flow rate of the first electromagnetism drive valve 70 as the first maximum flow rate, and sets a directive flow rate of the second electromagnetism drive valve 80 as the second maximum flow rate. The directive flow rate means a flow rate of the fluid containing vapor fuel which flows through the first passage 64 or the second passage 65, when the first electromagnetism drive valve 70 or the second electromagnetism drive valve 80 is operated by a directive (the first driving command signal or the second driving command signal). The ECU 10 shifts to S110 after S104.

In S105, the ECU 10 determines whether the target purge flow rate is more than or equal to the second maximum flow rate. When the target purge flow rate is more than or equal to the second maximum flow rate (S105:YES), the ECU 10 shifts to S106. When the target purge flow rate is less than the second maximum flow rate (S105:NO), the ECU 10 shifts to S107.

In S106, the ECU 10 sets a directive flow rate of the first electromagnetism drive valve 70 as a value calculated by subtracting the second maximum flow rate from the target purge flow rate, and sets a directive flow rate of the second electromagnetism drive valve 80 as the second maximum flow rate. Then, the ECU 10 shifts to S110.

In S107, the ECU 10 determines whether the target purge flow rate is more than or equal to the first maximum flow rate. When the target purge flow rate is more than or equal to the first maximum flow rate (S107:YES), the ECU 10 shifts to S108. When the target purge flow rate is less than the first maximum flow rate (S107:NO), the ECU 10 shifts to S109.

In S108, the ECU 10 sets a directive flow rate of the first electromagnetism drive valve 70 as 0, and sets a directive flow rate of the second electromagnetism drive valve 80 as the target purge flow rate. Then, the ECU 10 shifts to S110.

In S109, the ECU 10 sets a directive flow rate of the first electromagnetism drive valve 70 as the target purge flow rate, and sets a directive flow rate of the second electromagnetism drive valve 80 as 0. Then, the ECU 10 shifts to S110.

In S110, the duty ratio (the first duty ratio and the second duty ratio) of the first driving command signal and the second driving command signal outputted to the first electromagnetism actuator 72 and the second electromagnetism actuator 82, respectively, is computed based on the directive flow rate set in S104, S106, S108, or S109. Here, when the directive flow rate is 0, the first duty ratio or the second duty ratio is computed as 0 so that the first electromagnetism drive valve 70 or the second electromagnetism drive valve 80 has the OFF drive. Moreover, when the directive flow rate is the first maximum flow rate or the second maximum flow rate, the first duty ratio or the second duty ratio is computed as 1 so that the first electromagnetism drive valve 70 or the second electromagnetism drive valve 80 has the ON drive. The ECU 10 shifts to S111 after S110.

In S111, the ECU 10 outputs the first driving command signal and the second driving command signal which are based on the first duty ratio and the second duty ratio computed in S110 to the first electromagnetism actuator 72 and the second electromagnetism actuator 82, respectively. Thereby, the first electromagnetism drive valve 70 and the second electromagnetism drive valve 80 are driven, and the fluid containing vapor fuel having the same flow rate as the directive flow rate set in S104, S106, S108, or S109 flows through the first passage 64 and the second passage 65.

The treatment shown in FIG. 4 is completed after S111. When the predetermined condition is satisfied even after the treatment is completed, the ECU 10 performs the treatment again. That is, the treatment is repeatedly executed while the predetermined condition is satisfied. The vapor fuel adsorbed on the canister 32 can be purged to the engine 20 by performing the treatment with the ECU 10.

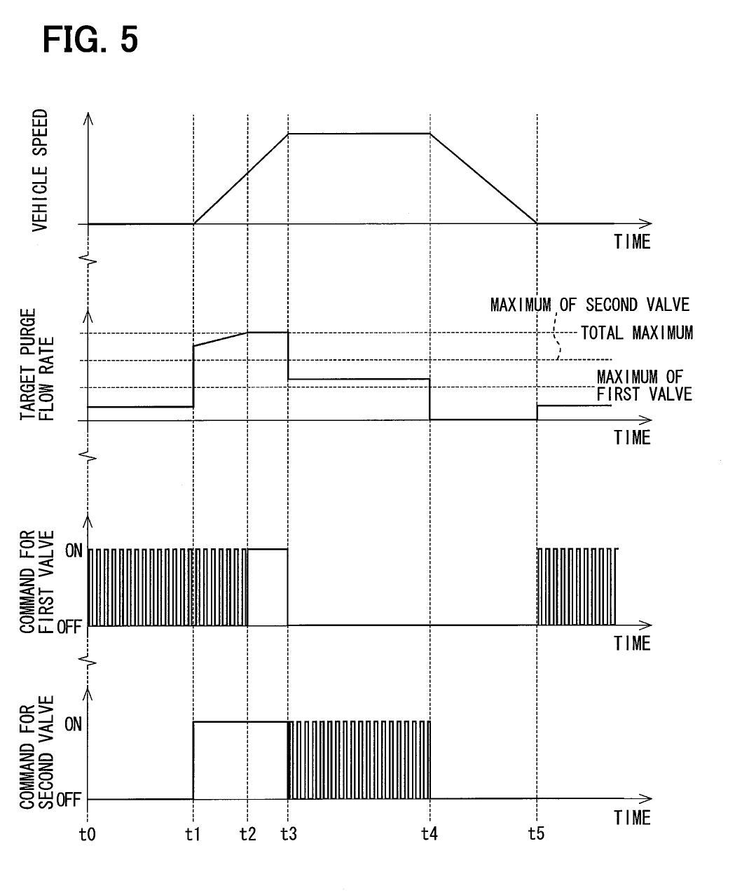

Operation example of the fuel vapor treatment apparatus 1 will be described referring to FIG. 5.

In a period from t0 to t1, the engine 20 of the vehicle is carrying out idle operation. At this time, a target purge flow rate is computed to be more than or equal to 0 and to be less than the first maximum flow rate. Therefore, the first electromagnetism drive valve 70 has PWM drive, and the second electromagnetism drive valve 80 has OFF drive. Therefore, vapor fuel is purged during the period t0-t1.

In a period from t1 to t2, the vehicle is in the accelerated state, so the rotation speed of the engine 20 is rising. Therefore, a target purge flow rate is computed to be more than or equal to the second maximum flow rate and to be less than the total maximum. Thereby, the first electromagnetism drive valve 70 has PWM drive, and the second electromagnetism drive valve 80 has ON drive. Therefore, vapor fuel is purged during the period t1-t2.

In a period from t2 to t3, the vehicle is kept in the accelerated state, a target purge flow rate is computed to be the total maximum. Thereby, both the first electromagnetism drive valve 70 and the second electromagnetism drive valve 80 have ON drive. Therefore, vapor fuel is purged during the period t2-t3. At this time, since both the first electromagnetism drive valve 70 and the second electromagnetism drive valve 80 are carrying out the ON drive, the purging with a large flow rate is possible.

In a period from t3 to t4, the vehicle is traveling at a fixed speed, so a target purge flow rate is computed to be more than or equal to the first maximum flow rate and to be less than the second maximum flow rate. Thereby, the first electromagnetism drive valve 70 has OFF drive, and the second electromagnetism drive valve 80 has PWM drive. Therefore, vapor fuel is purged during the period t3-t4.

In a period from t4 to t5, the vehicle is in the decelerated state, the rotation number of the engine 20 is falling. Therefore, a target purge flow rate is computed to be set to 0. Thereby, both the first electromagnetism drive valve 70 and the second electromagnetism drive valve 80 have OFF drive. Therefore, the purging of vapor fuel is stopped (purging cut) during the period t4-t5.

After the timing t5, the vehicle is stopped and the engine 20 is carrying out idle operation, so a target purge flow rate is computed to be more than or equal to 0 and to be less than the first maximum flow rate. Therefore, the first electromagnetism drive valve 70 has PWM drive, and the second electromagnetism drive valve 80 has OFF drive. Therefore, vapor fuel is purged after the timing t5.

According to the first embodiment, when the computed target purge flow rate is less than the computed total maximum, the ECU 10 controls the falling timing of the first driving command signal and the falling timing of the second driving command signal to differ from each other. Therefore, the first valve component 71 and the second valve component 81 are restricted from being closed at the same timing. Thereby, the pulsation sound of the pressure pulsation is reduced, and the air-fuel ratio is restricted from being varied among the cylinders 21 of the engine 20, when the first valve component 71 and the second valve component 81 are driven.

Generally, when the negative pressure in the intake pipe 40 is large, for example, at the idling time of the engine 20, the pressure pulsation tends to become large at the valve drive time. According to the present embodiment, the pressure pulsation and the pulsation sound can be reduced. Therefore, the present embodiment is especially effective in the scene where silence is better, for example, at the idling time of the engine 20.

Moreover, the flow rate is adjusted in each of the first passage 64 and the second passage 65, and the target purge flow rate is achieved with the totaled flow rate of the first passage 64 and the second passage 65. Therefore, the pressure pulsation and the variation of the air-fuel ratio among the cylinders can be made small compared with a case where a flow rate is adjusted in one passage.

More specifically, when a target purge flow rate is less than the total maximum, the ECU 10 controls the first duty ratio and the second duty ratio to differ from each other. Therefore, the falling timing of the first driving command signal differs from the falling timing of the second driving command signal.

More specifically, when a target purge flow rate is less than the total maximum, either one of the first duty ratio and the second duty ratio may be set to 0 or 1 in a predetermined period, and the other of the first duty ratio and the second duty ratio is set to a value larger than 0 and smaller than 1 in the predetermined period. Thus, the falling timing of the first driving command signal differs from the falling timing of the second driving command signal. By controlling in this way, either one of the first electromagnetism drive valve 70 and the second electromagnetism drive valve 80 will be in the ON state or OFF state in the predetermined period. Therefore, the number of drive (open) times driving (opening) the first valve component 71 and the second valve component 81 can be reduced, so the life of the first electromagnetism drive valve 70 and the second electromagnetism drive valve 80 can be made long.

Moreover, either one of the first maximum flow rate and the second maximum flow rate is set to correspond to the target purge flow rate at the idling time where it is strongly required to be quiet and to reduce the variation between the cylinders, and the other of the first maximum flow rate and the second maximum flow rate is set to a flow rate which supplements a shortage of the target purge flow rate relative to the first or second maximum flow rate. That is, the first maximum flow rate of the first electromagnetism drive valve 70 and the second maximum flow rate of the second electromagnetism drive valve 80 are made different from each other. Therefore, pulsation sound and variation in the air-fuel ratio between the cylinders can be reduced to the minimum, while the target purge flow rate at the idling time is satisfied.

### Second Embodiment

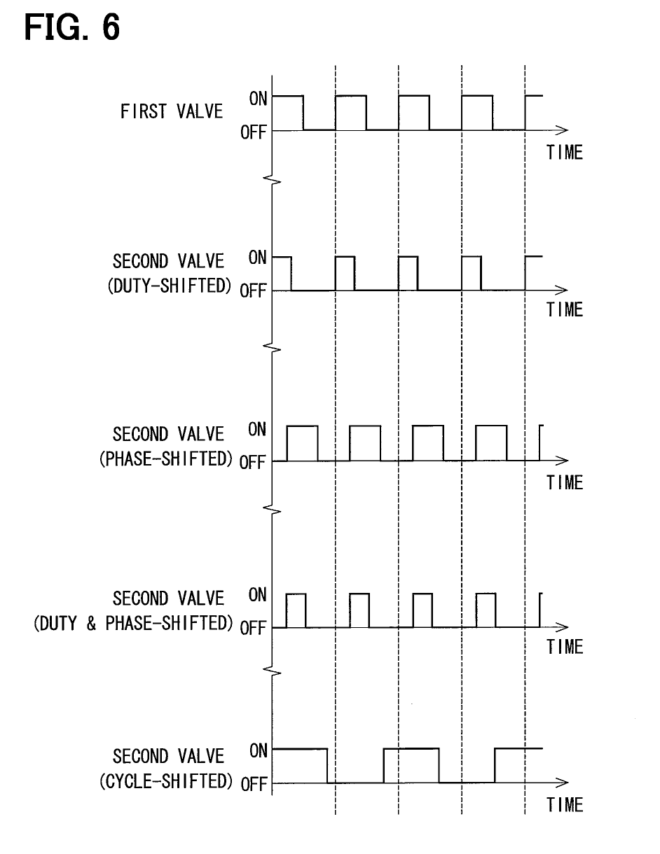

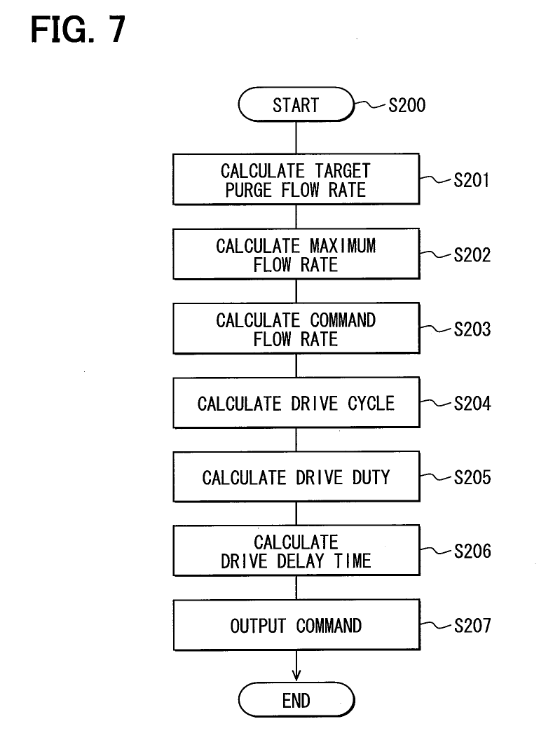

A second embodiment will be described referring to FIGS. 6 and 7. The vapor fuel treatment method of the second embodiment is different from that of the first embodiment while the mechanical structure of the second embodiment is the same as that of the first embodiment.

In the second embodiment, when a target purge flow rate is less than a total maximum, the ECU 10 controls a first driving command signal and a second driving command signal to be different in at least one of the duty ratio, phase, and cycle period. Thus, a raising timing of the first driving command signal and a raising timing of the second driving command signal differ from each other, or a falling timing of the first driving command signal and a falling timing of the second driving command signal differ from each other.

For example, as shown in FIG. 6, when the first driving command signal is output to the first valve 70, the second driving command signal is made different from the first driving command signal in the duty ratio, the phase, both of the duty ratio and the phase, or the cycle period (frequency). When the first driving command signal is compared with the second driving command signal shifted in the duty ratio, the falling timing of the first driving command signal differs from the falling timing of the second driving command signal. When the first driving command signal is compared with the second driving command signal shifted in the phase, both of the duty ratio and the phase, or the cycle period (frequency), the rising timing of the first driving command signal and the rising timing of the second driving command signal are different from each other, or the falling timing of the first driving command signal and the falling timing of the second driving command signal are different from each other.

Next, vapor fuel purging treatment by the ECU 10 of the second embodiment is explained based on FIG. 7. The vapor fuel purging treatment is started at S200 of FIG. 7 when a predetermined condition is met, for example, when the feedback control using the air fuel ratio sensor 53 is being performed after the completion of warming-up of the engine 20, similarly to the first embodiment.

In S201, the target flow rate calculator 10a of the ECU 10 computes a target purge flow rate. Then, the ECU 10 shifts to S202.

In S202, the total maximum calculator 10b of the ECU 10 computes a first maximum flow rate, a second maximum flow rate, and a total maximum which is a sum of the first maximum flow rate and the second maximum flow rate. Then, the ECU 10 shifts to S203.

In S203, the ECU 10 sets a directive flow rate of the first electromagnetism drive valve 70 and a directive flow rate of the second electromagnetism drive valve 80. Specifically, in the case where a target purge flow rate is more than or equal to the total maximum, the directive flow rate of the first electromagnetism drive valve 70 is set as a first maximum flow rate, and the directive flow rate of the second electromagnetism drive valve 80 is set as a second maximum flow rate. On the other hand, when a target purge flow rate is less than the total maximum, the ECU 10 sets a directive flow rate of the first electromagnetism drive valve 70 and a directive flow rate of the second electromagnetism drive valve 80 based on the target purge flow rate. Then, the ECU 10 shifts to S204 after S203.

In S204, the ECU 10 computes the cycle period (frequency) for the first driving command signal and the second driving command signal. Then, the ECU 10 shifts to S205.

In S205, the ECU 10 computes the duty ratio (first duty ratio and second duty ratio) for the first driving command signal and the second driving command signal based on the directive flow rate set in S203. For example, when the directive flow rate of the first electromagnetism drive valve 70 is set as a first maximum flow rate in S203 and when the directive flow rate of the second electromagnetism drive valve 80 is set as a second maximum flow rate, both a first duty ratio and a second duty ratio are set to 1. Then, the ECU 10 shifts to S206 after S205.

In S206, the ECU 10 computes the delay time of the second driving command signal relative to the first driving command signal. Here, for example, in the case where the cycle period is the same between the first driving command signal and the second driving command signal, if the delay time is set to 0, the rising timing of the first driving command signal and the rising timing of the second driving command signal will become the same. In contrast, if the delay time is set to be a value larger than 0 and smaller than the cycle period, the rising timing of the first driving command signal and the rising timing of the second driving command signal are made to be different from each other. Then, the ECU 10 shifts to S207 after S206.

In S207, the ECU 10 outputs the first driving command signal and the second driving command signal which are based on the cycle period computed in S204, the first duty ratio and the second duty ratio computed in S205, and the delay time computed in S206 to the first electromagnetism actuator 72 and the second electromagnetism actuator 82, respectively. Thereby, the first electromagnetism drive valve 70 and the second electromagnetism drive valve 80 are driven, and the fluid containing vapor fuel having the same flow rate as the directive flow rate set in S203 flows through the first passage 64 and the second passage 65.

The vapor fuel purging treatment shown in FIG. 7 is completed after S207. When the predetermined condition is satisfied even after the treatment is completed, the ECU 10 performs the treatment again. That is, the treatment is repeatedly executed while the predetermined condition is satisfied. The vapor fuel adsorbed on the canister 32 can be purged to the engine 20 by performing the treatment with the ECU 10.

For example, when the cycle period is computed to be the same between the first driving command signal and the second driving command signal in S204, when the first duty ratio is set to differ from the second duty ratio in S205, and when the delay time is computed to be 0 in S206, as shown in the second valve (duty-shifted) of FIG. 6, the falling timing becomes different between the first driving command signal and the second driving command signal (duty-shifted).

For example, when the cycle period is computed to be the same between the first driving command signal and the second driving command signal in S204, when the first duty ratio and the second duty ratio are set the same in S205, and when the delay time is set to a value larger than 0 in S206, as shown in the second valve (phase-shifted) of FIG. 6, the rising timing and the falling timing are made different between the first driving command signal and the second driving command signal (phase-shifted).

For example, when the cycle period is computed to be the same between the first driving command signal and the second driving command signal in S204, when the first duty ratio is set to differ from the second duty ratio in S205, and when the delay time is set to a value larger than 0 in S206, as shown in the second valve (duty&phase-shifted) of FIG. 6, the rising timing and the falling timing are made different between the first driving command signal and the second driving command signal (duty&phase-shifted).

For example, when the cycle period is computed to be different between the first driving command signal and the second driving command signal in S204, when the first duty ratio and the second duty ratio are set the same in S205, and when the delay time is set to 0 in S206, as shown in the second valve (cycle-shifted) of FIG. 6, the rising timing and the falling timing are made different between the first driving command signal and the second driving command signal (cycle-shifted) except for the initial pulse.

According to the second embodiment, when the target purge flow rate is less than the total maximum, the ECU 10 controls at least one of the duty ratio, phase, and cycle period to be different between a first driving command signal and a second driving command signal, so that the rising timing of the first driving command signal differs from the rising timing of the second driving command signal and/or that the falling timing of the first driving command signal differs from the falling timing of the second driving command signal.

Therefore, the first valve component 71 and the second valve component 81 are restricted from being opened or closed at the same timing. Thereby, the pulsation sound of the pressure pulsation is reduced, and the air-fuel ratio is restricted from being varied among the cylinders 21 of the engine 20, when the first valve component 71 and the second valve component 81 are driven.

Moreover, by controlling the duty ratio, phase, and cycle period to be different between the first driving command signal and the second driving command signal, the fluid containing vapor fuel can be more uniformly distributed to each of the cylinders 21, therefore variation in the air-fuel ratio between the cylinders can be reduced further.

### Other Embodiments

In other embodiment, the first electromagnetism drive valve and the second electromagnetism drive valve may be integrated with each other. Moreover, the vapor fuel treatment apparatus is further equipped with a housing which defines the first passage and the second passage, and the first electromagnetism drive valve and the second electromagnetism drive valve may be accommodated in the housing. In this case, components of the vapor fuel treatment apparatus can be modularized and the conveyance or attachment to the vehicle can be performed easily.

The vapor fuel treatment apparatus is applicable not only the fout-cylinder engine but an engine of any numbers of cylinders. Moreover, the vapor fuel treatment apparatus is also applicable to an idling stop vehicle.

Such changes and modifications are to be understood as being within the scope of the present disclosure as defined by the appended claims.

What is claimed is:

1. A vapor fuel treatment apparatus including a canister which adsorbs vapor fuel generated in a fuel tank, the vapor fuel adsorbed by the canister being introduced into an internal combustion engine via an intake pipe, the vapor fuel treatment apparatus comprising:
a first electromagnetism drive valve arranged in a first passage having a first end connected to the canister and a second end connected to the intake pipe, the first electromagnetism drive valve having
a first valve component which reciprocates to open or close the first passage, and
a first electromagnetism actuator which drives the first valve component in a valve opening direction when a first driving command signal having a rectangle pulse form is input;
a second electromagnetism drive valve arranged in a second passage having a first end connected to the canister and a second end connected to the intake pipe, the second electromagnetism drive valve having
a second valve component which reciprocates to open or close the second passage, and
a second electromagnetism actuator which drives the second valve component in a valve opening direction when a second driving command signal having a rectangle pulse form is input;
a target flow rate calculator which calculates a target purge flow rate of fluid including the vapor fuel to be introduced into the internal combustion engine based on an operational status of the internal combustion engine;
a total maximum calculator which calculates a sum of a first maximum flow rate and a second maximum flow rate as a total maximum, the first maximum flow rate being a flow rate of fluid flowing through the first passage when the first valve component has a maximum opening, the second maximum flow rate being a flow rate of fluid flowing through the second passage when the second valve component has a maximum opening; and
a control part which carries out a pulse width modulation control for the first electromagnetism drive valve and the second electromagnetism drive valve by outputting the first driving command signal and the second driving command signal to the first electromagnetism actuator and the second electromagnetism actuator respectively in a manner that a sum of a flow rate of fluid flowing through the first passage and a flow rate of fluid flowing through the second passage agrees with the target purge flow rate, wherein
the control part controls the first driving command signal and the second driving command signal to be different from each other in a rising timing or a falling timing, when the target purge flow rate is less than the total maximum.

2. The vapor fuel treatment apparatus according to claim 1, wherein
when the target purge flow rate is less than the total maximum, the control part controls a first duty ratio of the first driving command signal and a second duty ratio of the second driving command signal to be different from each other.

3. The vapor fuel treatment apparatus according to claim 2, wherein
when the target purge flow rate is less than the total maximum, the control part controls one of the first duty ratio and the second duty ratio to be 0 or 1 in a predetermined period and controls the other of the first duty ratio and the second duty ratio to be a value larger than 0 and smaller than 1 in the predetermined period.

4. The vapor fuel treatment apparatus according to claim 1, wherein
when the target purge flow rate is less than the total maximum, the control part controls a phase of the first driving command signal and a phase of the second driving command signal to be different from each other.

5. The vapor fuel treatment apparatus according to claim 1, wherein
when the target purge flow rate is less than the total maximum, the control part controls a cycle period of the first driving command signal and a cycle period of the second driving command signal to be different from each other.

6. The vapor fuel treatment apparatus according to claim 1, wherein
the first electromagnetism drive valve and the second electromagnetism drive valve are configured to have the first maximum flow rate and the second maximum flow rate respectively, and
the first maximum flow rate and the second maximum flow rate are set different from each other.
